(19) United States
(12) Patent Application Publication
(10) Pub. No.: US 2026/0212021 A1
(43) Pub. Date: Jul. 23, 2026

(54) SECURE BOOT OPERATIONS IN NETWORK APPLIANCES

(71) Applicant: Ivanti, Inc., South Jordan, UT (US)

(72) Inventors: Ananth Sundapalayam, Bengaluru (IN); Kalaimani Kanagaraj, Tiruvannamalai (IN); Ravi Kumar Telikapalli, Hyderabad (IN)

(73) Assignee: Ivanti, Inc., South Jordan, UT (US)

(21) Appl. No.: 19/456,814

(22) Filed: Jan. 22, 2026

(30) Foreign Application Priority Data
Jan. 23, 2025 (IN) 202511005541

(51) Int. Cl. G06F 21/57; G06F 8/65; G06F 9/4401

(52) U.S. Cl. CPC G06F 21/575; G06F 8/65; G06F 9/4416; G06F 2221/034

(57) ABSTRACT

An embodiment includes a method for upgrading a network appliance while preserving existing data. Upon receiving an upgrade trigger, the network appliance downloads and stores an updated package containing at least a new kernel and a new ramdisk. The network appliance identifies the currently active image partition and the separate factory-reset partition, then copies the updated kernel and ramdisk into the factory-reset partition. The boot loader's main configuration file is modified to direct the network appliance to boot from the updated factory-reset partition. After rebooting, the appliance designates the updated partition as the new active image, enabling the updated kernel and ramdisk to mount installation scripts and complete the upgrade process without impacting stored data.

### CROSS REFERENCE TO RELATED APPLICATION

This application claims the benefit of and priority to Indian Provisional Application No. 202511005541 filed Jan. 23, 2025, which is incorporated herein by reference in its entirety.

### FIELD

The embodiments described in this disclosure are related to secure boot operations in network appliances and upgrade procedures related thereto.

### BACKGROUND

During boot operations of network appliances, the network appliance is vulnerable to malicious boot loaders and compromised kernel software images such as the Linux Kernel software image. For instance, the integrity of the boot loader is not verified by the basic input/output system (BIOS). Accordingly, it is vulnerable to malicious code inserted into the boot loader or malicious code replacement. Similarly, integrity of the kernel software image is not verified. Accordingly, bypasses may be incorporated into the kernel software image, which can circumvent restrictions or integrity checks performed later in initialization processes.

In some conventional systems, a secure boot process may be implemented to address the vulnerabilities in the boot loader or the kernel software image. However, implementation of the secure boot process typically includes partitioning or repartitioning of the hardware of the network appliance. The partitioning or repartitioning of operational network appliances results in data loss especially during deployment of a unified extensible firmware interface (UEFI) in place of the BIOS. Accordingly, there is a need in the field of network appliance security to enable the improvement of the boot process. Additionally, there is a need in this field to enable upgrades to operational systems such that data of the network appliance is maintained during the upgrade.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect, an embodiment includes method of upgrading images on a network appliance while preserving data on the network appliance. The method may include receiving a trigger to an upgrade the network appliance from an active image installed on the network appliance to an updated image. The updated image includes an updated kernel and an updated ramdisk. The method may include downloading, to the network appliance, an updated package including the updated image. The method may include storing the updated package at the network appliance. The method may include determining which partition of multiple partitions of the network appliance is an active image partition that is currently allocated to the active image. The method may include further determining which partition of the multiple partitions of the network appliance is a factory reset partition. The factory reset partition stores a factory reset image. The method may include copying the updated kernel and the updated ramdisk to the factory reset partition. The method may include modifying a main configuration file of a boot loader to access the updated kernel and the updated ramdisk in the factory reset partition. The method may include rebooting the network appliance such that the boot loader implements the modified main configuration file to access the updated kernel and the updated ramdisk from the factory reset partition and designating the factory reset image partition as an updated active image partition. The method may include mounting, by the updated kernel, the updated ramdisk and installation scripts using the updated package.

Another aspect includes a secure network appliance that includes a unified extensible firmware interface (UEFI), a boot loader, a kernel, a diagnostics partition, and a disk. The UEFI may include one or more databases storing authorization information related to boot loaders and kernels. The boot loader signed with a first signature. The kernel signed with a second signature. During a secure boot sequence, the UEFI is configured to determine validity of the boot loader based on the authorization information in the one or more databases and the first signature, and to load the boot loader or to block binaries of the boot loader based on the validity determination. After the boot loader is loaded by the UEFI, the boot loader is configured to determine validity of the kernel based on authorization information of the one or more databases and the second signature, and to load the kernel or to block binaries of the kernel based on the validity determination. After the kernel is loaded by the boot loader, the kernel is configured to verify an initial ram file system (initramfs) using an initramfs key, and mount the initramfs based on verification of the initramfs. The first signature and the second signature are based on private keys. The UEFI, the boot loader, the kernel, the initramfs, and the diagnostic partition are included on the disk. The diagnostics partition that is separate from the UEFI, the boot loader, and the kernel used in the secure boot sequence. In response to the UEFI blocking the binaries of the boot loader or the boot loader blocking the binaries of the kernel, the diagnostic partition is configured to generate and enable access to a diagnostic log that indicates a failed boot attempt and identifies a reason for the failed boot attempt. The diagnostics partition may include a rescue operating system and a diagnostic script configured to launch the rescue operating system, generate the diagnostic log, store the diagnostic log in a persistent storage location, and launch a network interface to enable access to the diagnostic log. The one or more databases may include one or both of a whitelist database storing valid signatures and public keys for authorized boot loaders and kernels, and a blacklist database storing signatures of non-secure boot loaders and non-secure kernels. In these and other embodiments, a determination of validity of the boot loader may include one or both of verification of the first signature of the boot loader against the valid signatures and public keys for authorized boot loaders, and verification that the first signature does not correspond to an entry in the blacklist database. A determination of validity of the kernel may include verification of the second signature of the kernel against the valid signatures and public keys for authorized boot loaders, and verification that the second signature does not correspond to an entry in the blacklist database.

Yet another aspect includes a method for performing a secure boot sequence in a network appliance. The method may include updating, prior to a boot of the network appliance, one or more databases stored in a unified extensible firmware interface (UEFI). The method may include triggering the UEFI by initiating a boot operation or power-up operation of the network appliance. The method may include determining, by the UEFI, whether a boot loader is valid based on authentication information in the one or more databases. The one or more databases may include one or both of a whitelist database that includes valid signatures and public keys of an authorized boot loader and an authorized kernel, and a blacklist database that includes signatures of non-secure boot loaders and non-secure kernels. The method may include disallowing binaries of the boot loader in response to the boot loader being invalid. In response to the boot loader being valid, the method may include loading the binaries of the boot loader and determining, by the boot loader, whether a kernel is valid based the authentication information in the one or more databases. The method may include disallowing binaries of the kernel in response to the kernel being invalid. In response to the kernel being valid, the method may include loading the binaries of the kernel, and mounting an initramfs by the loaded kernel. Verification of the boot loader and the kernel may be based on one or more encryption keys that are used to sign the boot loader and the kernel by a vendor. For instance, the determination of validity of the boot loader may include authenticating a cryptographic signature of the boot loader against a public key enrolled in the whitelist database, or detection of signatures of the boot loader in the blacklist database. Similarly, in some embodiments, the determination of validity of the kernel may include authenticating a cryptographic signature of the boot loader against a public key enrolled in the whitelist database, or detection of signatures of the boot loader in the blacklist database. Responsive to disallowing the boot loader or kernel binaries, the method may further include triggering a recovery script and a recovery operating system stored in a diagnostic partition of the network appliance. After the recover script and the recovery operating system are triggered, the recover script and the recovery operating system are configured to generate, by the recovery script, a diagnostic log indicating a failure condition associated with an invalid boot loader or an invalid kernel, store the diagnostic log at a storage location; and launch a network interface configured to provide access to the diagnostic log and to communicate an alert to an administrator.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an existing network appliance and an existing boot sequence;

FIG. 2 is a block diagram of an example operating environment in which some embodiments of the present disclosure can be implemented;

FIG. 3 is a block diagram of an example of the secure network appliance implemented in the operating environment of FIG. 2;

FIG. 4 is a flow chart of an example method of a secure boot sequence implemented in a network appliance such as the secure network appliance of FIG. 3;

FIG. 5 is a block diagram of a fresh installation of a base image in the secure network appliance of FIG. 3;

FIG. 6 is a block diagram of an upgrade overview from existing network appliance of FIG. 1 to a secure boot build of the secure network appliances of FIG. 2;

FIG. 7 is a flow chart of an example method of upgrading an existing network appliance to a secured network appliance that may be implemented in the operating environment of FIG. 2;

FIGS. 8A-8G depict example partition diagrams showing an upgrade process;

FIGS. 9A-9C is a flow chart of another example method of network appliance upgrade that may be implemented in the operating environment of FIG. 2;

FIG. 10 illustrates an example computer system configured for secure boot sequence operations,

all according to at least one embodiment described in the present disclosure.

### DESCRIPTION OF SOME EXAMPLE EMBODIMENTS

The embodiments described in this disclosure are related to secure boot operations in network appliances and upgrade procedures related thereto. For instance, the present disclosure describes a secure network appliance, a rescue subsystem implemented to detect improper operation of the secure network appliance, multiple upgrade processes to modify existing network appliances to the secure network appliances in the field, and a preliminary process to enable the upgrade processes in existing network appliances having insufficient partition sizes.

In detail, some existing network appliances suffer from insecure boot operations, which expose the network appliances to malicious actors. For instance, once access is gained to the network appliance, the malicious actor might modify one or more components involved in the boot operation such as the kernel, which enables wide access to operations of the network appliance. Accordingly, some embodiments of the present disclosure relate to a network appliance that includes a secure boot sequence (referred to as a secure network appliance) in which the components involved in the boot are verified. The secure boot sequence implements a verification chain that enables multiple components involved in the boot operation to be verified sequentially.

Additionally, in the secure boot sequence, there are several points of failure. For instance, one or more components might fail a verification process, signatures might be outdated, etc. Accordingly some embodiments include the secure network appliance that includes a rescue subsystem. The rescue subsystem is configured to detect a boot failure, its cause(s), and notify an administrator. The rescue subsystem operates across in a separate partition to reduce accessibility to malicious actors.

Additionally still, the secure network appliance can be implemented on existing network appliances through an upgrade process. However, these existing network appliances are operational in a client environment. Accordingly, some embodiments of the present disclosure are directed to upgrade processes that can be implemented on operational network appliances without or with minimal data loss. The disclosed upgrade process might fail at least some portion of the existing network appliances because the allocations to specific disk partitions. Accordingly, some embodiments describe an additional process that checks and reallocates sizes of the partitions prior to execution of the upgrade process.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures is not intended to limit the scope of the systems and methods, as claimed, but is merely representative of example configurations of the systems and methods.

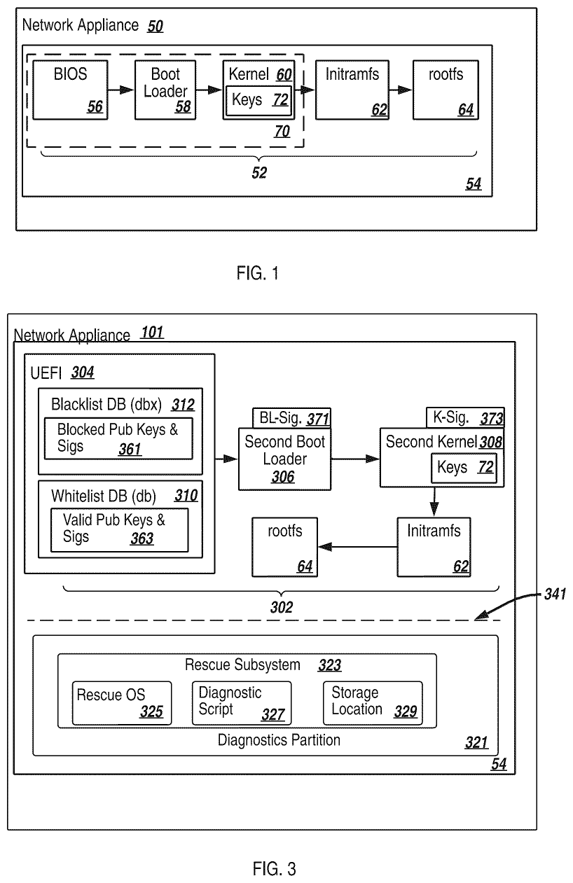

FIG. 1 is a block diagram of an existing network appliance 50 and an existing boot sequence 52 that is implemented in the existing network appliance 50. The existing network appliance 50 includes a disk 54 that includes a basic input/output system (BIOS) 56, a boot loader 58, a kernel 60 such as a Linux™ Kernel, an initial ram file system (initramfs) 62, and a root file system (rootfs) 64. The BIOS 56, the boot loader 58, and the kernel 60 are included in dashed box 70 indicating that the BIOS 56, the boot loader 58, and the kernel 60 are involved in an insecure portion of the existing boot sequence 52.

The existing boot sequence 52 is initiated by the BIOS 56. For example, responsive to a power signal, the BIOS 56 runs a check on the disk 54 and then executes the boot loader 58. The BIOS 56 might need to locate the boot loader 58, after it is located, the BIOS 56 loads the boot loader 58 into memory and transfers control of the existing network appliance 50 to the boot loader 58.

In detail, the existing network appliance 50 may include a master boot record (“MBR”). The MBR might also be stored in a sector of the disk 54 or may be stored on a storage device. The MBR contains the boot loader 58. The BIOS 56 locates and executes the MBR. The MBR then executes the boot loader 58. The boot loader 58 may be a grand unified boot loader legacy (“GRUB Legacy”). The boot loader 58 loads the kernel 60 (e.g., a kernel image that represents the kernel 60). The kernel 60 may be selectable when multiple kernels 60 are included in the existing network appliance 50. The boot loader 58 may also execute initrd images.

The kernel 60 has wide control of the existing network appliance 50 following the boot sequence 52. During the boot sequence 52, however, the kernel 60 establishes and mounts the initramfs 62 and the rootfs 64. The initramfs 62 is used temporarily until the rootfs 64 is mounted. The initramfs 62 and the rootfs 64 are used to initiate and execute run level operations. In the existing network appliance 50, the kernel 60 may verify the initramfs 62 and the rootfs 64 using initramfs keys 72. The initramfs keys 72 are used during verification and decryption operations associated with mounting the initramfs 62 and the rootfs 64.

In the existing network appliance 50, the boot loader 58 and the kernel 60 are not validated. Accordingly, these components represent the insecure portion of the existing boot sequence 52. For instance, the boot loader 58 is susceptible to malicious code insertion or replacement, which may not be detected. Similarly, the kernel 60 is not validated. Accordingly, attackers may set up a bypass to the kernel 60. The bypass to the kernel 60 may bypass restrictions or integrity check performed by the kernel 60 such as verifications of the initramfs 62 and the rootfs 64 using the keys 72.

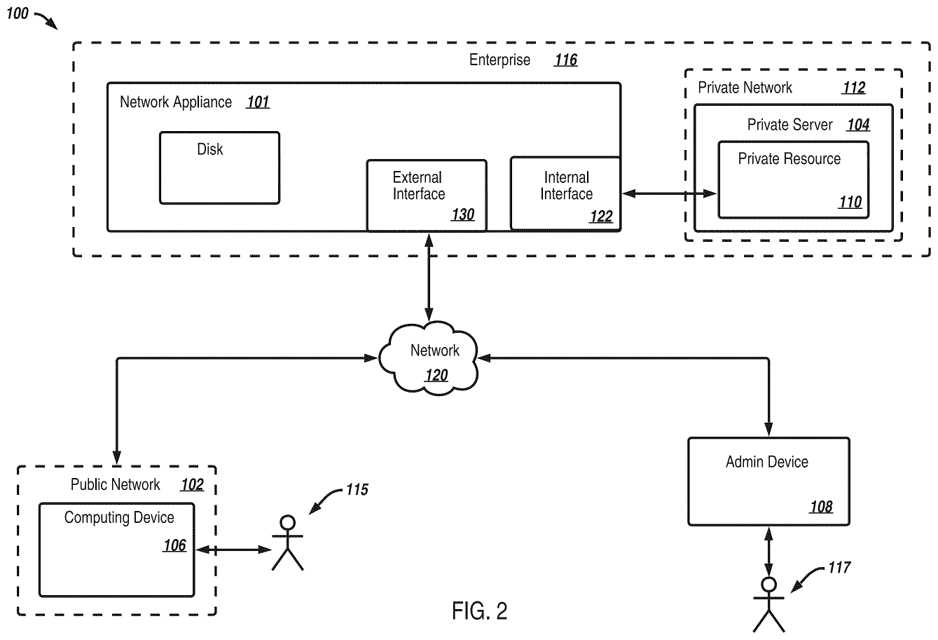

Embodiments of the present disclosure are directed to a secured network appliance 101 as described in FIGS. 2 and 3 that improves the existing network appliance 50 and the existing boot sequence 52. Additionally, some embodiments provide systems and methods for upgrading existing network appliance 50 to the secured network appliance 101 and resolving issues that may occur during use of the secured network appliance 101 and that may occur during an upgrade process.

FIG. 2 is a block diagram of an example operating environment 100 in which some embodiments of the present disclosure can be implemented. The operating environment 100 includes a secure network appliance 101 that is configured to implement a secure boot sequence (described elsewhere in the present disclosure). Additionally, the operating environment 100 enables upgrades from the configurations of the existing network appliance 50 and the existing boot sequence 52 of FIG. 1 to the secure network appliance 101 and a secure boot sequence.

In the operating environment 100, the secured network appliance 101 is implemented to route and process network traffic from a public network 102 to a private network 112. The operating environment 100 further includes an administrative device 108 (hereinafter, “admin device 108”) and a private server 104. The components of the operating environment 100 are configured to communicate data and information via the network 120 to perform secure network access, and perform upgrade processes described in methods 700 and 900 that modify the existing network appliance 50 to the secured network appliance 101 as described in the present disclosure. Each of these components are described in the following paragraphs.

The network 120 may be comprised of many interconnected computer systems and communication links. The communication links may be hardware links, optical links, satellite or other wireless communications links, wave propagation links, or any other mechanisms for communication of information. Various communication protocols may be used to facilitate communication between the systems of FIG. 1. These communication protocols may include TCP/IP, HTTP protocols, wireless application protocol (WAP), vendor-specific protocols, customized protocols, and others. In one embodiment, the network 120 is at least partially comprised of the Internet, or another communication network including a local area network (LAN), a wide area network (WAN), a wireless network, an intranet, a private network, a public network, a switched network, and combinations of these, and the like.

The public network 102 includes a computing device 106. The public network 102 includes network locations outside the private network 112 such as public-facing or publicly accessible portions of the internet. For example, the computing device 106 of the public network 102 may access the network 120 via a public internet connection. The public network 102 is accessible to any computing device with minimal restrictions. Accordingly, there is at least a possibility that the computing device 106 is not authorized to access the private server 104 of the private network 112. Additionally, the public network 102 may be susceptible to or might act as an attack surface for malicious attacks. The secured network appliance 101 is configured, among other operations, to provide a virtual private network (VPN) via which the computing device 106 can access the private server 104 while reducing the risk of malicious attacks.

The computing device 106 may include hardware-based computer system that is configured to communicate with the other components of the operating environment 100 via the network 120. The computing device 106 may include any computer device or system that can communicate network traffic with the secured network appliance 101 and the private server 104. Generally, the computing device 106 includes a device that is operated by an individual, who may be associated with an enterprise 116. For instance, the computing device 106 might include workstations of the enterprise 116, servers, data storage systems, printers, telephones, internet of things (IOT) devices, smart watches, etc. The computing device 106 may also include virtual machines, which may include a portion of a single processing unit or one or more portions of multiple processing units, which may be included in multiple machines.

The computing device 106 may be associated with a user 115. The phrase “associated with” when describing the relationship between the computing device 106 and the user 115 indicates that the user 115 generally or regularly operates the computing device 106.

The admin device 108 includes a hardware-based computer device or collection thereof configured to communicate with the other components of the operating environment 100 via the network 120. For instance, the admin device 108 is configured to communicate management data with the secured network appliance 101 or the existing network appliance 50 of FIG. 1. For instance, the admin device 108 may communicate or initiate upgrades and updates to the secured network appliance 101 or the existing network appliance 50. The admin device 108 may also be configured to receive data and information from the secure network appliance 101 such as error messages, boot failure messages, and the like.

The admin device 108 may be associated with an administrator 117. The administrator 117 may be an individual, a set of individuals, or a system that interfaces with the admin device 108. In some examples, the administrator 117 may provide input such as admin input to the admin device 108. The input provided by the administrator 117 may form data and information used to define the instructions or triggers for upgrades.

The admin device 108 may be included in one or both of the private network 112 or in the public network 102. For instance, in some embodiments, the admin device 108 may be included in the public network 102. In these embodiments, the communication of data and information may be via the secured network appliance 101 and be received at an external interface 130 thereof. Alternatively, the admin device 108 may be located within the private network 112. In these embodiments, the data and information communicated by the admin device 108 originates within the private network 112 and received at the secured network appliance 101 at an internal interface 122 thereof.

The private network 112 is isolated from the public network 102. The private network 112 is used to connect and secure the private server 104. Within the private network 112 access to a private resource 110 is controlled. For instance, access to the private resource 110 is prevented by unauthorized users (e.g., the user 115) and/or unauthorized software applications. Access to the private resource 110 is allowed from authorized users (e.g., the user 115) and authorized software applications. The private network 112 may include a secure environment. The private network 112 may be associated with the enterprise 116.

The secured network appliance 101 includes a hardware-based computer device or collection thereof that is configured to communicate with the other components of the operating environment 100 via the network 120. In the depicted embodiment, the secured network appliance 101 is a virtual private network (VPN) appliance that provides VPN services to enable secure, encrypted connections between the computing device 106 and the private network 112.

The secure network appliance 101 may include the external interface 130, the internal interface 122 and the disk 54 described with reference to FIG. 1. The disk 54 may include components described with reference to FIG. 3, some of which are included in the existing network appliance 50.

The external interface 130 receives network traffic from the computing device 106 and is an interface between the public network 102 and the secure network appliance 101. Additionally, responses are communicated from the secure network appliance 101 to the computing device 106 via the external interface 130. The internal interface 122 receives network traffic from the private server 104 of the private network 112 and communicates the network traffic to the secure network appliance 101.

Components of the secure network appliance 101 may be implemented using hardware including a processor, a microprocessor (e.g., to perform or control performance of one or more operations), a field-programmable gate array (FPGA), or an application-specific integrated circuit (ASIC). The components may be implemented using a combination of hardware and software. Implementation in software may include rapid activation and deactivation of one or more transistors or transistor elements such as may be included in hardware of a computing system (e.g., the network appliance 101, the private server 104, or the computing device 106 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more computing devices 106, one or more secure network appliances 101, one or more private servers 104, one or more admin devices 108, one or more networks 120, or any combination thereof. Moreover, the separation of various components and devices in the examples described herein is not meant to indicate that the separation occurs in all examples. Moreover, it may be understood with the benefit of this disclosure that the described components and servers may generally be integrated together 1into a single component or server or separated into multiple components or servers.

FIG. 3 is a block diagram of an example of the secure network appliance 101 implemented in the operating environment 100 of FIG. 2. The secured network appliance 101 is configured to perform a secure boot sequence 302. The secure network appliance 101 improves security of the existing network appliance 50 of FIG. 1. The secure network appliance 101 includes the disk 54, which further includes a UEFI 304, a second boot loader 306, and a second kernel 308.

The UEFI 304 includes a whitelist database (db) 310 and a blacklist database (dbx) 312. The db 310 stores valid signatures and public keys or public key certificates 363 of authorized boot loaders and kernels such as the second boot loader 306 and the second kernel 308. The valid signatures and public keys 363 are associated with boot loaders (such as the second boot loader 306) and kernels (such as the second kernel 308) that the UEFI 304 is authorized for use in the secure network appliance 101. The dbx 312 includes signatures and/or public keys or public key certificates 361 of non-secure images such as images of non-secure or revoked boot loaders and non-secure kernels. The signatures and public keys 361 may include hashes, certificates, etc. that can be used to identify non-secure boot loaders and non-secure kernels.

In the depicted embodiment, the db 310 and the dbx 312 are included in the UEFI 304. In other embodiments, the UEFI 304 does not include the db 310 or the dbx 312. In these and other embodiments, the UEFI 304 or firmware operational on the network appliance 101 accesses the db 310 or the dbx 312 that is included elsewhere on the disk 54. The UEFI 304 or the firmware enforces an “allow list” using the db 310 and a “revocation” operation using the dbx 312.

The UEFI 304 may replace the BIOS 56 of the existing network appliance 50. Accordingly, the UEFI 304 may be configured to load the second boot loader 306. In addition, in the secure boot sequence 302, the UEFI 304 verifies that a signature (in the Figures “BL-sig.”) 371 of the second boot loader 306 corresponds to the valid signatures and public keys 363 of the db 310. In response to the signature 371 of the second boot loader 306 corresponding to the signatures and public keys 361 of the dbx 312, the second boot loader 306 may be blocked. Alternatively, in response to the signature 371 of the second boot loader 306 not corresponding to the valid signatures and public keys 363 of the db 310, the second boot loader 306 may be blocked. For instance, binaries of the second boot loader 306 may not be allowed.

In response to the signature 371 of the second boot loader 306 corresponding to the valid signatures or the public keys 363 of the db 310, the second boot loader 306 may be allowed. Accordingly, the second boot loader 306 is loaded by the UEFI 304.

After it is loaded, the second boot loader 306 verifies a kernel signature (in the Figures “K-sig.”) 373 of the second kernel 308. The kernel signature 373 of the second kernel 308 is authenticated against the valid signature and public keys 363 of the db 310. In response to the kernel signature 373 corresponding to the signatures and public keys 361 of the dbx 312 or to the kernel signature 373 not corresponding the signatures and public keys 363 of the db 310, binary of the second kernel 308 may be blocked or not allowed.

In some embodiments, the second boot loader 306 does not directly utilize the db 310 of the UEFI 304. Instead in these and other embodiments, the second boot loader 306 uses its keyring (e.g., embedded certificates or machine owner key (MOK)). The keyring of the second boot loader 306 may be based on the authorized public keys of the db 310 in some cases.

After the second kernel 308 is loaded, it may use the keys 72 to validate and/or decrypt information related to the initramfs 62 and rootfs 64 as described with reference to FIG. 1. The second kernel 308 may include a Linux Kernel 4.17 in some embodiments. The second kernel 308, which includes a valid signature, is loaded by the second boot loader 306. After it is loaded, the second kernel 308 mounts the initramfs 62, various hardware drivers followed by mounting the rootfs, which may include a logical volume management (LVM).

Cryptographic keys are used to verify the second boot loader 306 and the second kernel 308. The cryptographic keys might be created for the secured network appliance 101 as well as other secured network appliances implemented in an operating environment. For instance, the cryptographic keys may be created during a manufacture operation or during current and rollback installations of the second boot loader 306 and the second kernel 308. The cryptographic keys may include a key pair including a private key and a public key. The vendor or developer may use the private keys for a cryptographic signature of the second boot loader 306 and the second kernel 308. The public keys or public key certificates of the key pair are stored in the db 310. Accordingly, the signatures 371/373 can be validated using the stored public keys. In other embodiments, other suitable key types may be implemented in the secure network appliance 101.

Accordingly, the secure boot sequence 302 may be prevented in response to either the second boot loader 306 or the second kernel 308 having an incorrect or mismatched signatures 371/373 or keys. Moreover, the private keys may be controlled by vendors or developers, which reduces or prevents attacks directed to the second boot loader 306 and the second kernel 308.

To generate the UEFI 304, relevant signatures may be provided to a manufacturer of the UEFI 304. The UEFI 304 includes a new UEFI binary with the signatures and keys 363/361 included in the databases 310 and 312. The UEFI 304 supplied with the current databases 310 and 312 may be available to update the BIOS 56 of FIG. 1. The signature may change with each image, which may require updating to the databases 310 and 312. In some embodiments, the keys may be asymmetric key pairs. In these and other embodiments the public keys or public key certificates may be stored and updated in the databases 310 or 312.

Accordingly, the UEFI 304 maintains the db 310 containing valid signatures and public keys 363 of the second boot loader 306 or second kernel 308 that it is configured to boot, as well as the dbx 312 containing the signatures and/or public keys 361 of non-secure images. The decision by the UEFI 304 to boot or not boot a particular image is based on the presence of the signature in the db 310 and absence from the dbx 312.

The second boot loader 306 may be a GRUB2 boot loader (e.g., on x86 systems) that is used to load the second kernel 308 or another suitable operating system. Hereinafter, the second boot loader 306 may be referred to as GRUB2. GRUB2 is allowed to load by UEFI 304 if its signature 371 matches the signature in the db 310. After loading, the second boot loader 306 checks for the OS (e.g., the second kernel 308) to be loaded. The second boot loader 306 loads the second kernel 308 after verifying the signature 373 of the second kernel 308.

The second kernel 308 may include the Linux Kernel 4.17 in some embodiments. The second kernel 308 is loaded by the second boot loader 306 after signature verification. It performs the task of mounting the initramfs 62, various hardware drivers followed by mounting the LVM.

To build the secure network appliance 101, the following operations may be performed. First, one or more asymmetric key pairs may be generated for the second boot loader 306 and the second kernel 308. For instance, a first asymmetric key pair may be generated for signing the second boot loader 306 and a second asymmetric key pair may be generated for signing the second kernel 308. Alternatively, one asymmetric key pair may be generated for both the second kernel 308 and the second boot loader 306. After the one or more key pairs are generated, binary for the second boot loader 306 may be created and signed. Additionally, binary of the second kernel 308 may be signed.

The signature of the second boot loader 306 and a public key of the binary of the second boot loader 306 may be packaged into an installation package. Additionally, the signature of the second kernel 308, the public key and the binary of the second kernel 308 may be packaged into the installation package. The installation packages may be used in a fresh install and an upgrade as described elsewhere in the present disclosure.

The secure boot sequence 302 may fail during one or more operations. For instance, the integrity verification of the second boot loader 306 or the second kernel 308 by the UEFI 304 may result in the secure network appliance 101 never transferring control to the second boot loader 306 or the second kernel 308. Accordingly, the secure boot sequence 302 may not proceed past an initial step in which the UEFI 304 is operational. Additionally, in some implementations of the secure network appliances 101, diagnostic details may not be fetched because the boot sequence is failed and/or remote and local interfaces may not be available.

Accordingly, in some embodiments, the disk 54 may include a dedicated diagnostics partition (hereinafter, “diagnostics partition”) 321 having a rescue subsystem 323. In FIG. 3, dashed line 341 indicates a separation between the diagnostics partition 321 and components involved in the secure boot sequence 302. The diagnostics partition 321 is a pre-configured diagnostic partition. The diagnostics partition 321 separates the components involved in the secure boot sequence 302 (e.g., 304, 306, 308, 320, 313, etc.) from the rescue subsystem 223. The diagnostics partition 321 may be set up on the secure network appliance 101 beforehand implementation in the field and is independent of the secure boot sequence 302.

The rescue subsystem 323 may include a rescue operating system (OS) 225 and a diagnostics script 327. The diagnostic script 327 may be a basic set of instructions that are read-only to launch the rescue OS 325 and store a log of the secure boot sequence 302 and its failure. Thus, when the secure boot sequence 302 fails, the rescue OS 325 is triggered at the diagnostics partition 321. For instance, triggering the recovery script and the recovery operating system may be based on a signed alternative bootOrder entry that may be selected by firmware when the second boot loader 306 is blocked. Alternatively, a GRUB menu entry may be selected when the kernel is blocked. The signed alternative bootOrder entry or the GRUB menu entry is dedicated to the rescue subsystem. The diagnostic script 327 is configured to log detailed UEFI failure information. The UEFI failure information may include a reason the secured boot sequence 302 failed or symptoms thereof. The log may be stored at least temporarily to a persistent storage location 329.

Additionally, in some embodiments, the diagnostic script 327 may be configured to temporarily launch a network interface (e.g., the internal interface 122 or the external interface 130 of FIG. 2). The network interface may enable access to the log in the storage location 329 or transmit the log to an admin device (e.g., the admin device 108 of FIG. 2). Thus, an admin might have access or possession of the log with diagnostic information indicating the second boot loader verification failed, the second kernel verification failed, signatures not found or found in the databases 310 or 312, etc. Based on this information, the administrator may take corrective action such as updating an image on the secured network appliance 101.

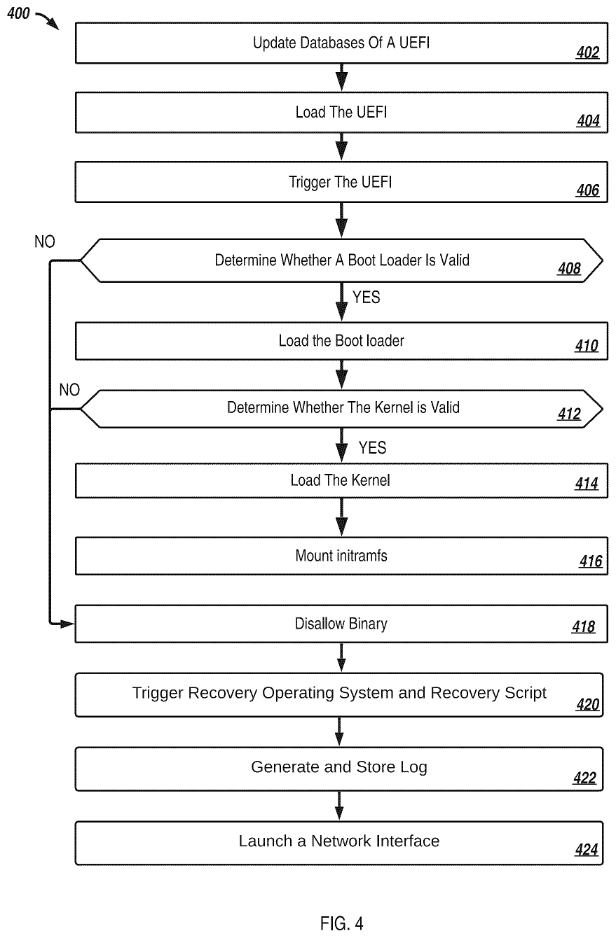

FIG. 4 is a flow chart of an example method 400 of a secure boot sequence (e.g., 302) implemented in a network appliance such as the secure network appliance 101 of FIG. 3. The method 400 may begin at block 402 in which databases of a UEFI may be updated. For instance, the db 310 and the dbx 312 of FIG. 3 may be updated in the UEFI 304. In some instances, operations of block 402 may occur before an upgrade or update to a network appliance.

At block 404, the UEFI may be loaded to the network appliance. The UEFI may be loaded during a new build of the network appliance or during an upgrade or update to the network appliance. For instance, the operations of block 402 may occur to update the databases of the UEFI. After the database update, the UEFI may be loaded to the network appliance. At block 406 the UEFI may be triggered. For instance, the network appliance may be booted or powered up. The boot or power up operation triggers the UEFI to bring the network appliance into an operational state.

At block 408 it may be determined whether a boot loader is valid. For instance, a cryptographic signature of the boot loader may be authenticated against public keys, public key certificates or authorized signatures of a whitelist database of the UEFI. Alternatively, the boot loader may be checked against keys, hashes, signatures, or binaries of a blacklist database, which are prevented. As an example in FIG. 3, the UEFI 304 may validate the second boot loader 306 based on the db 310.

In response to the boot loader not being valid (“NO” at block 408), the method 400 may proceed to block 418 in which binaries (of the boot loader) may be disallowed. In response to the boot loader being valid (“YES” at block 408), the method 400 may proceed to block 410 in which the boot loader is loaded by the UEFI.

At block 412, it may be determined whether a kernel or kernel image is valid. Validation of the kernel or kernel image may be based on a cryptographic signature of the kernel. Specifically, public keys stored in the UEFI may be accessed and used to validate the cryptographic signature of the kernel. Additionally or alternatively, the signature of the kernel may be checked to ensure it does not exist in a blacklist database. For instance, presence of the signature or a hash thereof in the blacklist database indicates the kernel is invalid. In response to the kernel not being valid (“NO” at block 412), the method 400 may proceed to block 418 in which binaries (of the kernel) may be disallowed. In response to the kernel being valid (“YES” at block 412), the method 400 may proceed to block 414 in which the kernel is loaded by the boot loader. At block 416, initramfs may be mounted. For instance, the initramfs may be mounted by the kernel, which is validated in block 412.

In some embodiments, the network appliance may include a diagnostic partition (e.g., 321 of FIG. 3). In these and other embodiments, the method 400 may include the operations of one or more or all of blocks 420, 422, and 424. For instance, in these embodiments, from the operation of block 418 in which the binaries have been disallowed (either the kernel or boot loader binaries), the method 400 may proceed to block 420. At block 420, a recovery script and a recovery operating system may be triggered. The recovery script and recovery operating system may be stored in the diagnostic partition which is separate from components used to implement other portions of the method 400. The recovery script and the recovery operating system may be triggered by the UEFI, a firmware, or the boot loader. For instance, triggering the recovery script and the recovery operating system may be based on a signed alternative bootOrder entry that may be selected by firmware when the second boot loader 306 is blocked. Alternatively, a GRUB menu entry may be selected when the kernel is blocked. The signed alternative bootOrder entry or the GRUB menu entry is dedicated to the rescue subsystem. Accordingly, triggering the recovery script and the recovery operating system may implement the entry responsive to the failures to load the binaries.

At block 422, a log may be generated and stored. For instance, the recovery script may generate a diagnostic log that accesses the status of the failure. For instance, if the operation of block 408 fails (e.g., the boot loader is invalid), then the diagnostic log indicates this failure. Similarly, if the operation of block 412 fails (e.g., the kernel is invalid), then the diagnostic log indicates this failure. Additionally, the diagnostic log may indicate a reason such as kernel signature invalid, etc. The diagnostic log may be stored at a storage location. In some embodiments, the storage location may be on the diagnostic partition. In other embodiments, the storage location may be on another portion of the disk. Additionally, in some embodiments the log might be encrypted. For instance, the recovery script may generate the log, encrypt the log, and store the log.

At block 424, a network interface may be launched. The network interface may be configured to enable access to the log. In some embodiments, the network interface may be a direct network interface with an admin device. An alert may be communicated via the network interface to make an administrator aware of the failure. Additionally or alternatively, the log may be communicated via the network interface.

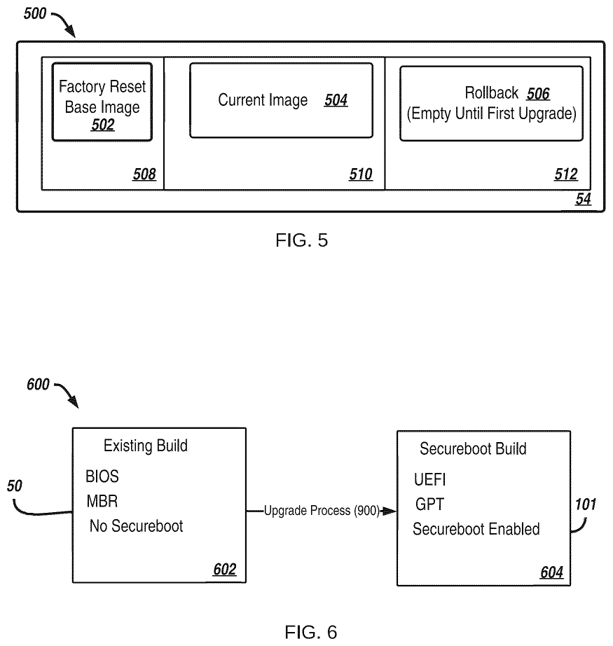

FIGS. 5-9C provide some additional details of the secured network appliance 101 and methods 700 and 900 that may be implemented to upgrade the existing network appliance 50 to the secured network appliance 101 at a disk-level of granularity. In at least some of FIGS. 5-9C partitions and sectors are described. With reference to the partitions in the FIGS. 5-9C and the diagnostic partition 321, the partitions include a division of a single physical storage drive (e.g., the disk 54) into multiple separate, logical sections that function as independent storage areas with its own drive letter or mount point.

FIG. 5 is a block diagram of a fresh installation 500 of a base image in the secure network appliance 101 of FIG. 3. FIG. 5 is described with combined reference to FIG. 3. For the fresh installation 500, a GUID partition table used to partition the disk 54 may be implemented to generate three partitions 508, 510, and 512. Binaries of the second boot loader 306 and configurations pertaining to the second boot loader 306 may be installed in a boot sector or a boot partition. In addition, public keys and signatures of the second boot loader 306 may be enrolled into the db 310 of the UEFI 304. The second kernel 308 and its signature and keys are then installed on the disk 54. As shown in FIG. 5, the partitions 508, 510, and 512 may include a first partition 508 in which a factory reset base image 502 is installed, a second partition 510 in which a current image 504 is installed, and a third partition 512, which is allocated for a rollback image 506. The factory reset base image 502 is a current version of the components (e.g., 304, 320, 313, 306, 64, 62, 308, etc.) of the secure network appliance 101. Additionally, the current image 504 is the current version. The rollback image is empty until a first upgrade.

FIG. 6 is a block diagram of an upgrade overview 600 from existing network appliances 50 of FIG. 1 and an existing build 602 of FIG. 6 to a secure boot build 604 the secure network appliances 101 of FIG. 2. More generally, FIG. 6 depicts an upgrade overview 600 from a network appliance implementing a non-secure boot sequence to network appliance implementing a secure boot sequence.

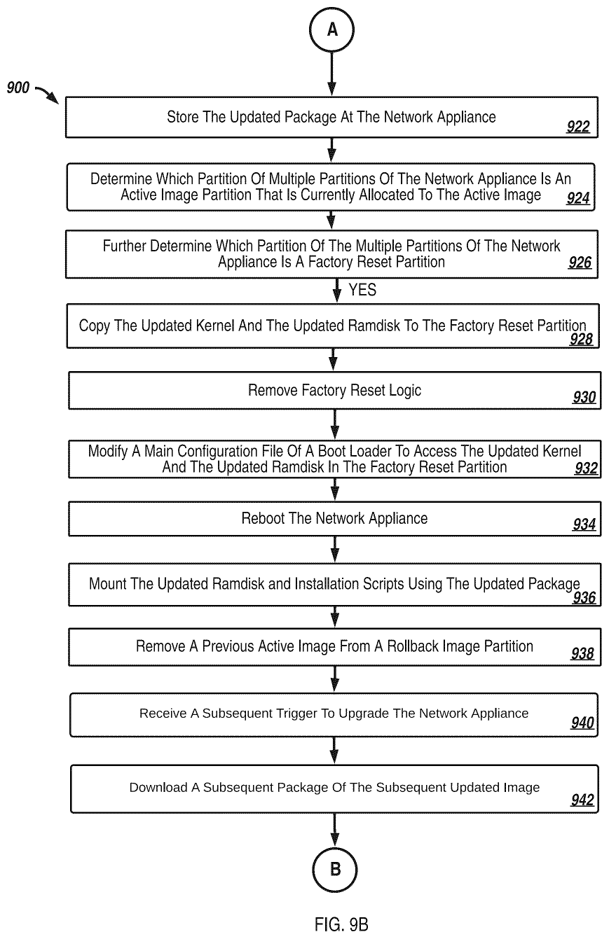

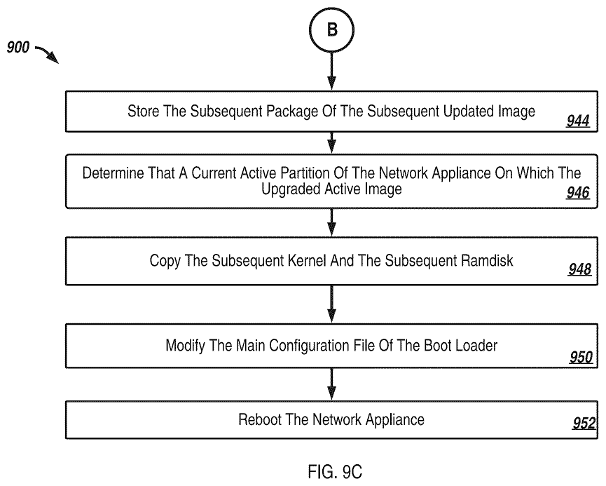

In some embodiments, prior to implementing an upgrade, a boot storage the assessment and boot partition size reallocation may be performed. For instance, partition sizes may be assessed and reallocated to ensure the upgrade is successfully implemented. Some additional details of the partition size assessment and allocation are provided with reference to FIG. 9.

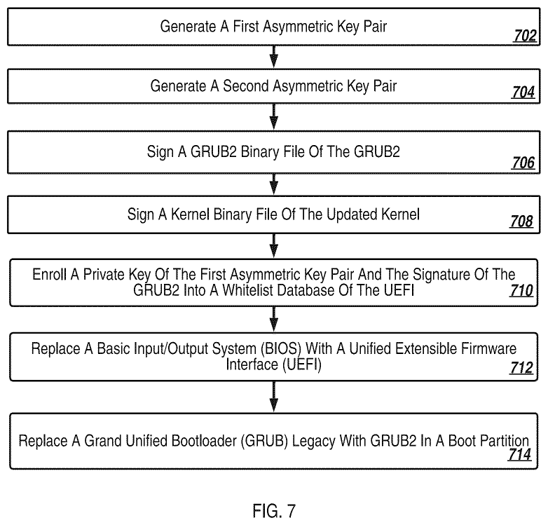

Referring to FIG. 6 and FIG. 7, in the upgrade overview 600, the existing network appliance 50 includes the existing build 602. The existing build 602 includes a BIOS (e.g., 56 of FIG. 1) and a master-boot record (MBR) partitioning scheme. In the existing build 602, a secure boot operation is not enabled. In FIG. 6, the existing build 602 may be upgraded to the secure network appliance 101 including a secure boot build 604. To upgrade the existing build 602, the MBR may be modified to a GPT partition, while data is preserved. Additionally, the BIOS is upgraded to the UEFI so that the UEFI is enabled on the secure network appliance 101 after a reboot operation. The upgrade overview 600 results in the existing network appliance 50 booting up on a secure boot-enabled build such as the secured network appliance 101.

To implement the upgrade depicted in the upgrade overview 600, a method 700 of upgrading the network appliance may be implemented. The method 700 is described with reference to the flowchart of method 700 of FIG. 7. The method 700 is implemented on existing network appliances (e.g., 50) without loss of data on the existing build 602. The method 700 is important because, in some circumstances, the existing network appliance (e.g., 50) is operational and deployed in a customer environment. Specifically, the existing network appliance may be actively used by an enterprise and deployed in an enterprise environment. Accordingly, preservation of data on the network appliance during the upgrade reduces or eliminates a need to remove the appliance from operation.

FIG. 7 is a flow chart of an example method 700 of upgrading an existing network appliance to a secured network appliance according to at least one embodiment of the present disclosure. The method 700 may begin at block 702, in which a first asymmetric key pair is generated. The first asymmetric key pair is configured for use in GRUB2 (e.g., the second boot loader 306) signing and validation. At block 704, a second asymmetric key pair is generated. The second asymmetric key pair is configured for use in kernel signing and validation. At block 706, a GRUB2 binary file of the GRUB2 is signed. The GRUB2 binary file is signed using the first asymmetric key pair. At block 708, a kernel binary file of the updated kernel is signed. The kernel binary file is signed using the second asymmetric key pair.

At block 710, a private key of the first asymmetric key pair and the signature of the GRUB2 are enrolled into a whitelist database of a UEFI. At block 712, a BIOS is replaced with the UEFI. The UEFI includes the whitelist database that includes signatures of authorized bootloaders. At block 714, a GRUB legacy is replaced with GRUB2. To replace the GRUB legacy, the method 700 might include changing a partition type from a MBR to a GUID partition table (e.g., the GPT in FIG. 6). The method 700 may then include creation an extensible firmware interface (EFI) system partition. The EFI system partition acts as a boot partition to receive the GRUB2. A GRUB binary of the GRUB2 is then installed into the EFI system partition. The keys (in particular the public key) and the signature of the GRUB2 are enrolled into the whitelist database of the UEFI.

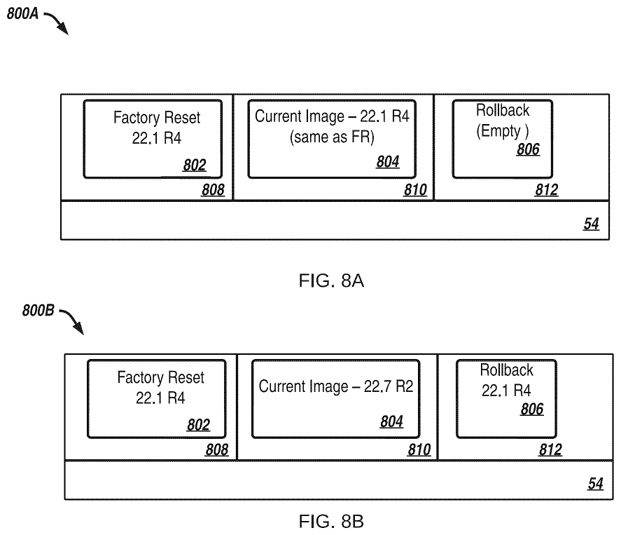

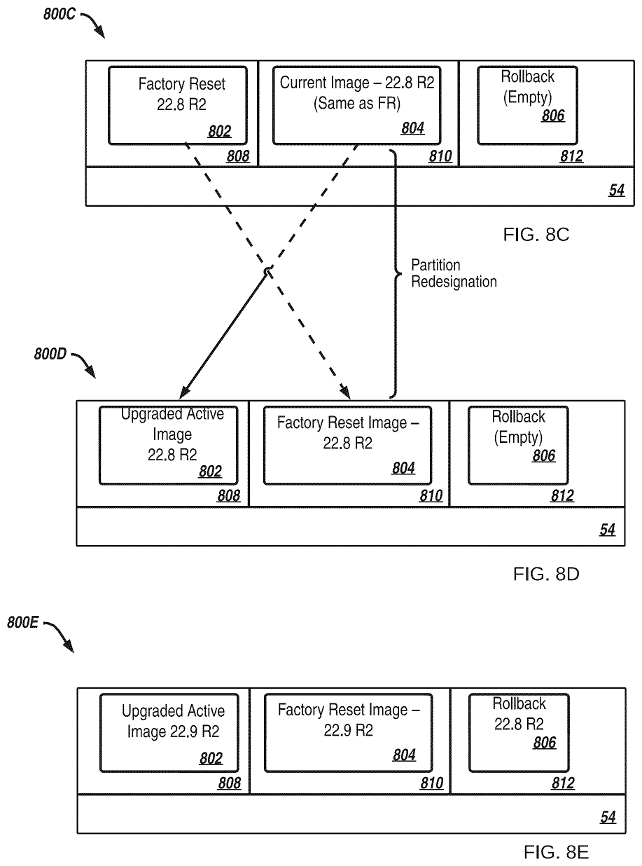

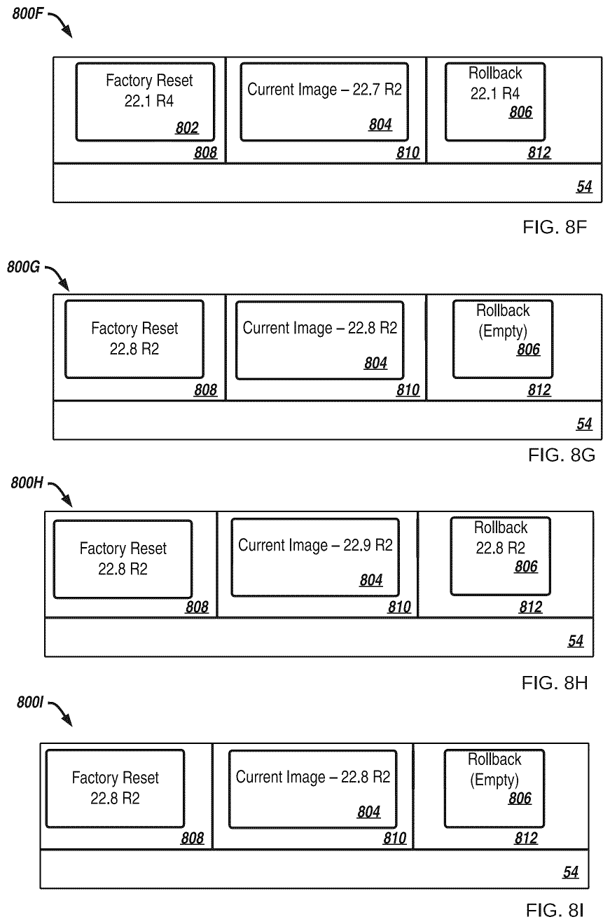

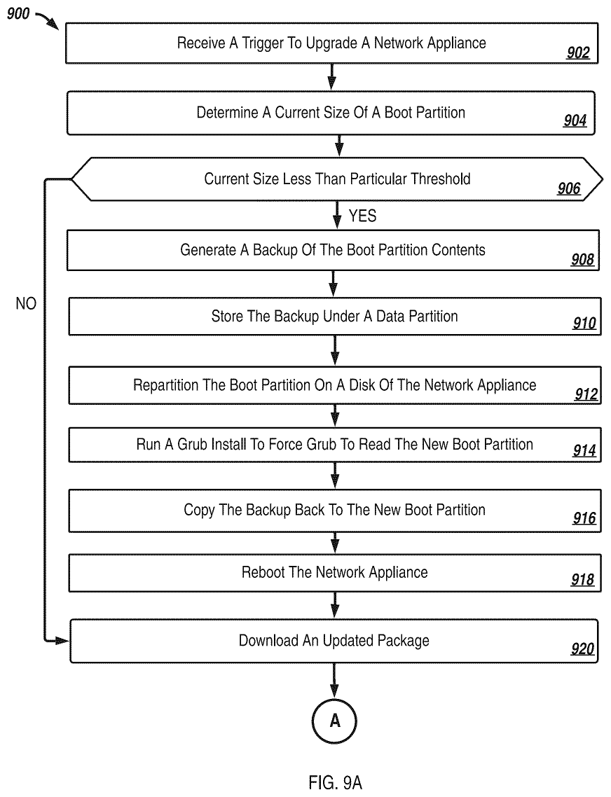

FIGS. 8A-8G depict example partition diagrams 800A-800G (generally, partition diagrams 800 or partition diagram 800). The partition diagrams 800 depict examples of upgrades to a network appliance. The partition diagrams 800A-800G include images (e.g., 802, 804, and 806) loaded on the disk 54 in three partitions 808, 810, and 812. The partition diagrams 800A-800G depict some example sequences or series of images loaded onto the three partitions 808, 810, and 812. The partition diagrams 800A-800G are described with reference to three image versions: 22.1R4 which is a first version in time; 22.7R2 which is an upgraded image later in time relative to 22.1 R4; 22.8R2 which is a second upgrade that includes a secure boot build (e.g., secure boot build 604 of FIG. 6); and 22.9R2 which is subsequent in time to 22.8R2.

Referring first to FIG. 8A, a first partition diagram 800A is depicted that shows a fresh installation (similar to FIG. 5) that may be implemented in some existing network appliances. In the first partition diagram 800A, the factory reset image 802 is 22.1R4, which is included in a first partition 808. The current or active image 804 is 22.1 R2 (e.g., the same as the factory reset image) is included in a second partition 810. The rollback image 806 is empty. The first partition diagram 800A is illustrative of a new or fresh installation in which there has not been upgraded, which leads to the rollback image 806 being empty. Generally, the rollback image 806 is an immediately preceding current or active image. Because there has not been an immediately preceding current image in the fresh installation, the rollback image 806 is empty.

Referring to FIG. 8B, a user or an administrator may trigger an upgrade from 22.1R4 to 22.7 R2. Responsive to the trigger, the partitions 808, 810, and 812 may change to a second partition diagram 800B of FIG. 8B. In the second partition diagram 800B, the factory reset image 802 remains 22.1 R4 as it is the first or fresh active image installed on the disk 54. The current image 804 is upgraded to 22.7 R2. Additionally, the rollback image 806 changes to 22.1 R4, which is the immediately prior current image 804 as described in FIG. 800A. The upgrade to 22.7 R2 is not an upgrade to a secure boot network appliance. The upgrade from the first partition diagram 800A to the second partition diagram 800B may represent a conventional upgrade.

The user or the admin may trigger an upgrade from 22.7R2 to 22.8R2, which is a secure boot build upgrade. The upgrade to the secure boot build may include conversion to GPT partitioning (e.g., the method 700 described with reference to FIG. 7), which may entail loss of existing factory reset partition. To address the loss of existing factory reset partition, modifications to conventional upgrades may be performed as depicted in the third partition diagram 800C of FIG. 8C (which is an intermediate diagram) and the fourth partition diagram 800D of FIG. 8D (which is a final diagram). Specifically, the upgrade image, 22.8R2, is installed as the factory reset image 802 and as the current image 804 during the upgrade process. Additionally, the rollback image 806 is removed. Accordingly, as shown in FIG. 8C, the factory reset image 802 is version 22.8 R2, the current image 804 is version 22.8 R2, and the rollback image 806 is empty.

The logic used to install the factory reset image 802 during a fresh install may be incorporated into the upgrade logic. Whenever the upgrade is invoked or triggered from a user interface, the upgrade logic invokes the factory reset installation script. Current factory reset logic wipes all partitions. Accordingly, the current factory reset logic is removed from upgraded logic to avoid removal of data from the network appliance. To perform the secure boot build upgrade depicted in FIGS. 8C and 8D, the factory reset installation script is invoked from the upgrade script. Additionally, the partitions 808, 810, and 812 are converted from MBR to GPT (e.g., as described in FIG. 7). A reboot on the factory reset image 802 of FIG. 8C carries out installation of a final secured boot build. In some instances, an additional reboot is necessary if interim build is not removed.

Additionally, from the third partition diagram 800C, the factory reset partition 808 is designated as the upgraded current or active partition as shown in the fourth partition diagram 800D. Accordingly, as shown in FIG. 8D, the first partition 808 includes the upgraded active image 22.8 R2 and is designated as the upgraded active image and the second partition 810 is designated as the factory reset image and includes the 22.8 R2 image. A fourth partition diagram 800D is essentially equivalent to the third partition diagram 800C of FIG. 8C except for the designations of the partitions 808 and 810. Redesignation of the partitions 808 and 810 enable the factory reset installation script to be invoked from the upgrade script.

FIG. 8E is a fifth partition diagram 800E that results from a subsequent updated image performed relative to the fourth partition diagram 800D. The subsequent upgrade maintains the data at the network appliance. To upgrade from the fourth partition diagram 800D to the fifth partition diagram 800E, the user or the admin may initiate a subsequent trigger to upgrade from the 22.8R2 image to the 22.9R2 image. The upgrade from 22.8R2 to the 22.9R2 may also be a secure boot build or another upgrade that may compromise the data on the network appliance.

The subsequent upgrade to 22.9R2 follows substantially similar steps to those of the upgrade from 22.7R2 to 22.8R2 except that the partitions 808 and 810 may not be redesigned. Without the redesignation of the partitions 808 and 810, the upgrade from the fourth partition diagram 800D to the fifth partition diagram 800E may be similar to the upgrade from the first partition diagram 800A of FIG. 8A to the second partition diagram 800B of FIG. 8B except the factory reset partition 810 includes the updated image (e.g., 22.9 R2). The prior version (e.g., 22.8 R2) may be installed in the rollback partition 812, which maintains the previous secure boot build availability.

The upgrade from the fourth partition diagram 800D to the fifth partition diagram 800E may include partition redesignation in some circumstances. In embodiments in which the partitions 808 and 810 are redesignated, the second partition 810, which is designated as the factory reset partition in the fourth partition diagram 800D may be redesignated as the upgraded active image in the fifth partition diagram 800E. Additionally, the partition 808, which is designated as the upgraded active image partition in the fourth partition diagram 800D may be redesignated as the factory reset image in the fifth partition diagram 800E. Thus, the subsequent upgrade 22.9R2 image is stored in the second partition 810. The main configuration file and installation scripts are directed to the factory reset partition. The factory reset logic was removed such that data removal is avoided and the factory reset installation script looks to the factory reset partition 810 for the subsequent upgraded image, 22.9 R2. The network appliance is reset which loads the image from the second partition 810. As described above, there is a redesignation process that redesignates the active and factory reset partitions. Thus, any subsequent upgrade functions substantially similarly with the active and factory reset partitions swapping designations.

FIGS. 8F-8I depict partition diagrams 800F-800G depicting a secure build upgrade if an upgrade to 22.8R2 was skipped and the admin or the user waits to a subsequent version—i.e., 22.9 R2 to perform the secure build upgrade. This upgrade process is shown in the sequence of partition diagrams 800F thru 800G.

In FIG. 8F, a sixth partition diagram 800F is depicted which is substantially similar to the second partition diagram 800B of FIG. 8B except the factory reset image and the rollback image are version 22.1 R4, and a current or active image is 22.7 R2. The active image 22.7 R2 is a version between 22.8 R2 (the secure build upgrade) and a subsequent upgrade 22.9 R2.

The upgrade process to 22.8 R2 (the secure build upgrade) occurs as described with reference to FIGS. 8B and 8C which results in a seventh partition diagram 800G of FIG. 8G. Compare FIGS. 8C and 8G, the partitions and images are substantially the same. This represents an intermediate upgrade from 22.7 R2 to 22.8 R2.

The second state is upgrading 22.8 R2 to 22.9R2, which is depicted in the eighth partition 800H of FIG. 8H. Specifically, the current image is the subsequent upgrade 22.9 R2 and the factory reset image as well as the rollback image is 22.8 R2. The version may then be rolled back from version 22.9 R2 to 22.8 R2 from the rollback image 806 as shown in a ninth partition diagram 800I of FIG. 8I.

FIGS. 9A-9C is a flow chart of an example method 900 of upgrading a network appliance that may be implemented in the operating environment 100 of FIG. 2 or another suitable operating environment. The method 900 may be implemented to upgrade from an insecure or conventional network appliance (e.g., 50 of FIG. 1) to a secure network appliance (e.g., 101 of FIG. 3). The upgrade process 900 may be configured to maintain data during the upgrade process of the method 900. For instance, conventional upgrade processes may result in data being deleted from the network appliance. That is, conventional upgrade processes may “wipe” or erase data from the network appliances. Accordingly, to perform the conventional upgrade processes, some network appliances must be pulled from the field, upgraded, and then returned. When the network appliances are pulled from the field, the data is backed up and then reinstalled following the conventional upgrade process. For instance, the data may be stored remotely from the network appliance while the upgrade is performed. However, this process consumes significant resources and introduces significant downtime of the network appliance. The method 900 is implemented to enable the network appliance to stay in operation and results in the data on the network appliance to be preserved or maintained. The method 900 is implemented at the network appliances to maintain data during the upgrade(s) and reduce a need to remove the network appliances from field operation.

The method 900 is described with reference to a network appliance, which prior to implementation of the method 900, includes multiple partitions. The multiple partitions include a factory reset partition that includes a base image for the network appliance, a current image partition that includes the active image, and a rollback image partition that includes a previous image. Additionally, in some embodiments, the multiple partitions additionally include a data partition that enable storage of files and directories. The method 900 may be implemented in other network appliances that have similar partitions. In some embodiments, the multiple partitions may be distributed across detected SCSI/SATA disks (SDAs) such as SDA1 (e.g., /dev/sda1), SDA2, SDA3, and SDA11. In these and other embodiments, the active image may be stored at SDA2, and the factory reset may be stored at SDA3, etc.

Referring to FIG. 9A, the method 900 may begin at block 902 in which a trigger is received to an upgrade the network appliance. The trigger may be configured to upgrade the network appliance from an active image installed on the network appliance to an updated image. The updated image includes an updated kernel and an updated ramdisk. Referring to FIGS. 8B and 8C, the trigger may be configured to upgrade from 22.7 R2 to 22.8 R2, which is the secure build upgrade.

At block 904, a current size of a boot partition on which the boot loader is stored may be determined. The determining the current size occurs after the trigger is received (at block 902) and prior to downloading the updated package of the updated image (at block 920). At block 906, it is determined whether the current size of the boot partition is less than a particular size threshold. For instance, the particular size threshold may be fifty (50) megabytes (Mb). Accordingly, below the 50 Mb, the boot partition may be too small to accept an upgraded image. Responsive to the current size being below the particular size threshold (“Yes” at block 906), the method may proceed to block 908. Responsive to the current size being above the particular size threshold (“No” at block 906), the method may proceed to block 920.

Blocks 908, 910, 912, 914, 916, and 918 are configured to change the size of the boot partition. The operations of 908, 910, 912, 914, 916, and 918 increase the size of the boot partition and prevent a failure during implementation of the method 900. The operations of 904, 906, 908, 910, 912, 914, 916, and 918 may be unnecessary and omitted for some network appliances. For instance, more modern network appliances may be known by an administrator to have sufficient partition sizes. Accordingly, blocks 904, 906, 908, 910, 912, 914, 916, and 918 might be omitted.

At block 908, a backup of the boot partition contents is generated. At block 910, the backup is stored under a data partition of the network appliance. At block 912, the boot partition is repartitioned on a disk (e.g., 54) of the network appliance such that a new boot partition is generated with a second size. The second size is greater than the current size and greater than the size threshold. For instance, the second size may be one hundred (100) Mb, one-hundred-and-fifty (150) Mb, or another suitable size. At block 914, a grand unified bootloader (GRUB) install is run. The grub install is run to force GRUB to read the new boot partition. At block 916, the backup is copied back to the new boot partition. At block 918, the network appliance is reboot. The network appliance is reboot such that the new boot partition having the second size is implemented on the network appliance and includes the backup.

At block 920, an update package is downloaded to the network appliance. The update package includes the updated image. Referring to FIG. 9B, at block 922, the updated package is stored at the network appliance. At block 924, it may be determined which partition of multiple partitions of the network appliance is an active image partition (also referred to in the present disclosure as a current image partition) that is currently allocated to the active (or current) image. At block 926, it may be further determined which partition of the multiple partitions of the network appliance is a factory reset partition. As described above, the factory reset partition stores a factory reset image or a base image as described above.

At block 928, the updated kernel and the updated ramdisk are copied to the factory reset partition. At block 930, factory reset logic may be removed. Removal of the factory reset logic wipes partitions from upgrade logic to avoid removal of all data. At block 932, a main configuration file of a boot loader may be modified. The main configuration file may be modified to access the updated kernel and the updated ramdisk in the factory reset partition.

At block 934, the network appliance is reboot. The network appliance is reboot such that the boot loader implements the modified main configuration file that accesses the updated kernel and the updated ramdisk from the factory reset partition.

At block 935, the factory reset image partition is designated as an updated active image partition. At block 936, the updated ramdisk and installation scripts are mounted using the updated package. The updated ramdisk and the installation scripts may be mounted by the updated kernel. At block 938, a previous active image may be removed from a rollback image partition.

As an example, the boot loader may be stored in a boot partition of the multiple partitions, which may be stored on SDA1. The active image partition is stored on SDA2, the factory reset partition is stored on SDA3, and the updated package is stored on SDA11. After performances of the operations of blocks 920, 922, 924, 926, 928, 930, 932, 934, 935, and 936, the SDA3 may be designated as the updated active image partition and include the active updated image running on the network appliance.

At block 940, a subsequent trigger may be received. The subsequent trigger may be received to upgrade the network appliance from the updated active image to a subsequent updated image. The subsequent updated image includes a subsequent kernel and a subsequent ramdisk. At block 942, a subsequent package of the subsequent updated image is downloaded. The subsequent package is downloaded to the network appliance.

Referring to FIG. 9C, at block 944, the subsequent package of the subsequent updated image is stored. The subsequent package may be stored in a data partition such as in SDA11 in some embodiments. At block 946, a current active partition may be determined. For instance, it may be determined that a current active partition of the network appliance on which the upgraded active image is stored is SDA3. For instance, the current active partition may include the previously designated factory reset partition following execution of operations of block 935.

At block 948, the subsequent kernel and the subsequent ramdisk are copied to the SDA2. For instance, active image partition is stored on SDA2 prior to execution of block 920. However, the active image partition may be redesignated as the factory reset partition as part of the operations of block 935. Thus for the subsequent upgrade, SDA2 is the factory reset partition.

At block 950, the main configuration file of the boot loader is modified. The main configuration file is modified to point to the factory reset partition (in this example SDA2). At block 952, the network appliance is reboot. The network appliance is reboot such that the boot loader accesses the subsequent kernel and the subsequent ramdisk from the factory reset partition (e.g., SDA2) and the subsequent kernel mounts the subsequent ramdisk and installation scripts using the subsequent package.

In some embodiments, the method 900 of FIG. 9 may be combined or partially combined with the method 700. In these embodiments, the updated package may include the signature of the GRUB2 binary file, a public key of the first asymmetric key pair, the signature of the kernel binary file, and a public key of the second asymmetric key pair. The updated package accordingly enables verification during a secure boot sequence by performing the upgrade that includes changes from the BIOS and MBR to the UEFI and GPT with the whitelist database.

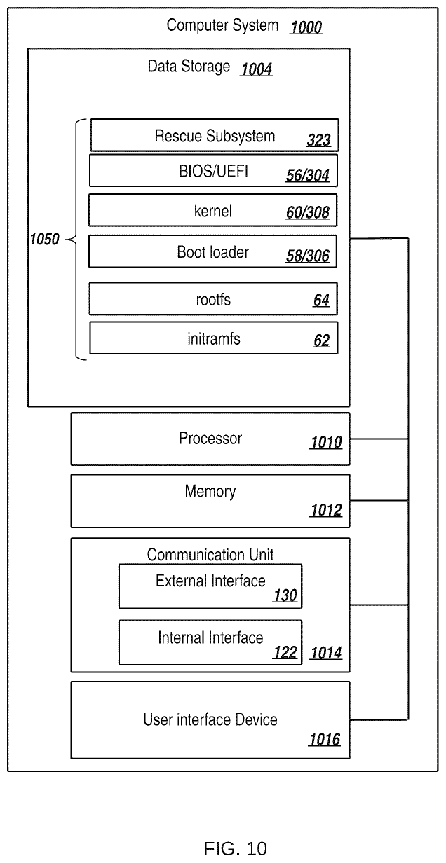

Although illustrated as discrete blocks, one or more blocks in FIGS. 4, 7, and 9 may be divided into additional blocks, combined into fewer blocks, or eliminated, depending on the desired implementation. One or more of the methods 400, 700, and 900 described in the present disclosure may be performed in a suitable operating environment such as the operating environment 100 of FIG. 1. The methods 400, 700, and 900 may be performed by the network appliance 50/101 or another computing device (e.g., 1000 of FIG. 10). In some embodiments, the network appliance 50/101 or another computing system may include or may be communicatively coupled to a non-transitory computer-readable medium (e.g., the memory 1012 of FIG. 10) having stored thereon programming code or instructions that are executable by one or more processors (such as the processor 1010 of FIG. 10) to cause a computing system or the network appliance 50/100 to perform or control performance of the methods 400, 700, and 900. Additionally or alternatively, the network appliance 50/100 or another computing device may include the processor 1010 described elsewhere in this disclosure that is configured to execute computer instructions to cause the network appliance 50/100 or another computing systems to perform or control performance of the methods 400, 700, and 900.

Further, modifications, additions, or omissions may be made to the methods 400, 700, and 900 without departing from the scope of the present disclosure. For example, the operations of methods 400, 700, and 900 may be implemented in differing orders. Furthermore, the outlined operations and actions are only provided as examples, and some of the operations and actions may be optional, combined into fewer operations and actions, or expanded into additional operations and actions without detracting from the disclosed embodiments.

FIG. 10 illustrates an example computer system 1000 configured for secure boot operations and upgrade procedures, according to at least one embodiment of the present disclosure. The computer system 1000 may be implemented in the operating environment 100 FIG. 2, for instance. Examples of the computer system 1000 may include the network appliances 50 and 101, the private server 104, the admin device 108, the computing device 106, or some combination thereof. The computer system 1000 may include one or more processors 1010, a memory 1012, a communication unit 1014, a user interface device 1016, and a data storage 1004 that includes one or more or a combination of the rescue subsystem 323, the BIOS/UEFI 56/304, the kernel 60/308, the boot loader 58/306, the rootfs 64, and the initramfs 62 (collectively, system modules 1050).

The processor 1010 may include any suitable special-purpose or general-purpose computer, computing entity, or processing device including various computer hardware or software modules and may be configured to execute instructions stored on any applicable computer-readable storage media. For example, the processor 1010 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 10, the processor 1010 may more generally include any number of processors configured to perform individually or collectively any number of operations described in the present disclosure. Additionally, one or more of the processors 1010 may be present on one or more different electronic devices or computing systems. In some embodiments, the processor 1010 may interpret and/or execute program instructions and/or process data stored in the memory 1012, the data storage 1004, or the memory 1012 and the data storage 1004. In some embodiments, the processor 1010 may fetch program instructions from the data storage 1004 and load the program instructions in the memory 1012. After the program instructions are loaded into the memory 1012, the processor 1010 may execute the program instructions.

The memory 1012 and the data storage 1004 may include computer-readable storage media for carrying or having computer-executable instructions or data structures stored thereon. Such computer-readable storage media may include any available media that may be accessed by a general-purpose or special-purpose computer, such as the processor 1010. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 1010 to perform a certain operation or group of operations.

The communication unit 1014 may include one or more pieces of hardware configured to receive and send communications. In some embodiments, the communication unit 1014 may include one or more of an antenna, a wired port, and modulation/demodulation hardware, among other communication hardware devices. In particular, the communication unit 1014 may be configured to receive a communication from outside the computer system 1000 and to present the communication to the processor 1010 or to send a communication from the processor 1010 to another device or network (e.g., the network 120 of FIG. 1). Some examples of the communication unit 1014 may include the internal interface 122 and the external interface 130.

The user interface device 1016 may include one or more pieces of hardware configured to receive input from and/or provide output to a user. In some embodiments, the user interface device 1016 may include one or more of a speaker, a microphone, a display, a keyboard, a touch screen, or a holographic projection, among other hardware devices.

The system modules 1050 may include program instructions stored in the data storage 1004. The processor 1010 may be configured to load the system modules 1050 into the memory 1012 and execute the system modules 1050. Alternatively, the processor 1010 may execute the system modules 1050 line-by-line from the data storage 1004 without loading them into the memory 1012. When executing the system modules 1050, the processor 1010 may be configured to perform one or more processes or operations described elsewhere in this disclosure.

Modifications, additions, or omissions may be made to the computer system 1000 without departing from the scope of the present disclosure. For example, in some embodiments, the computer system 1000 may not include the user interface device 1016. In some embodiments, the different components of the computer system 1000 may be physically separate and may be communicatively coupled via any suitable mechanism. For example, the data storage 1004 may be part of a storage device that is separate from a device, which includes the processor 1010, the memory 1012, and the communication unit 1014, that is communicatively coupled to the storage device. The embodiments described herein may include the use of a special-purpose or general-purpose computer including various computer hardware or software modules, as discussed in greater detail below.

Further, modifications, additions, or omissions may be made to the methods without departing from the scope of the present disclosure. For example, the operations of methods may be implemented in differing orders. Furthermore, the outlined operations and actions are only provided as examples, and some of the operations and actions may be optional, combined into fewer operations and actions, or expanded into additional operations and actions without detracting from the disclosed embodiments.

The embodiments described herein may include the use of a special purpose or general purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the systems and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claim is:

1. A method of upgrading images on a network appliance while preserving data on the network appliance, the method comprising:
receiving a trigger to an upgrade the network appliance from an active image installed on the network appliance to an updated image, wherein the updated image includes an updated kernel and an updated ramdisk;
downloading, to the network appliance, an updated package including the updated image;
storing the updated package at the network appliance;
determining which partition of multiple partitions of the network appliance is an active image partition that is currently allocated to the active image;
further determining which partition of the multiple partitions of the network appliance is a factory reset partition, wherein the factory reset partition stores a factory reset image;
copying the updated kernel and the updated ramdisk to the factory reset partition;
modifying a main configuration file of a boot loader to access the updated kernel and the updated ramdisk in the factory reset partition;
reboot the network appliance such that the boot loader implements the modified main configuration file to access the updated kernel and the updated ramdisk from the factory reset partition and designating the factory reset image partition as an updated active image partition; and
mounting, by the updated kernel, the updated ramdisk and installation scripts using the updated package.

2. The method of claim 1, wherein:
the boot loader is stored in a boot partition of the multiple partitions,
the boot partition is stored on SDA1;
the active image partition is stored on SDA2;
the factory reset partition and the updated active image partition are stored on SDA3; and
the updated package is stored on SDA11.

3. The method of claim 2, further comprising:
receiving a subsequent trigger to upgrade the network appliance from the updated active image to a subsequent updated image, wherein the subsequent updated image includes a subsequent kernel and a subsequent ramdisk;
downloading, to the network appliance, a subsequent package of the subsequent updated image;
storing the subsequent package of the subsequent updated image to SDA11;
determining that a current active partition of the network appliance on which the upgraded active image is stored is SDA3;
copying the subsequent kernel and the subsequent ramdisk to SDA2;
modifying the main configuration file of the boot loader to point to SDA2;
reboot the network appliance such that the boot loader accesses the subsequent kernel and the subsequent ramdisk from SDA2 and the subsequent kernel mounts the subsequent ramdisk and installation scripts using the subsequent package.

4. The method of claim 1, further comprising:
determining a current size of a boot partition on which the boot loader is stored;
responsive to the current size being below a particular size threshold, generating a backup of the boot partition contents and storing the backup under a data partition;
repartitioning the boot partition on a disk of the network appliance such that a new boot partition is generated with a second size, wherein the second size is greater than the current size;
running a grub install to force grub to read the new boot partition;
copying the backup back to the new boot partition; and
rebooting the network appliance such that the new boot partition having the second size is implemented on the network appliance and includes the backup.

5. The method of claim 4, wherein the determining the current size occurs after the trigger is received and prior to downloading the updated package of the updated image.

6. The method of claim 4, wherein the particular size threshold is fifty (50) megabytes (Mb).

7. The method of claim 1, further comprising removing a previous active image from a rollback image partition.

8. The method of claim 1, further comprising:
replacing a basic input/output system (BIOS) with a unified extensible firmware interface (UEFI); and
replacing a grand unified bootloader (GRUB) legacy with GRUB2 in a boot partition.

9. The method of claim 8, further comprising:
generating a first asymmetric key pair configured for use in GRUB2 signing;
generating a second asymmetric key pair that is configured for use in kernel signing;
signing a GRUB2 binary file of the GRUB2;
signing a kernel binary file of the updated kernel; and
enrolling a public key of the first asymmetric key pair and the signature of the GRUB2 into a whitelist database of the UEFI,
wherein the updated package includes:
the signature of the GRUB2 binary file,
the public key of the first asymmetric key pair,
the signature of the kernel binary file, and
a public key of the second asymmetric key pair.

10. The method of claim 8, wherein the UEFI includes a whitelist database that includes signatures of authorized bootloaders.

11. The method of claim 10, wherein the replacing the GRUB legacy includes:
changing a partition type from a master boot record (MBR) to a GUID partition table;
creating an extensible firmware interface (EFI) system partition that acts as the boot partition
installing a GRUB binary of the GRUB2 into the EFI system partition; and
enrolling keys and a signature of the GRUB2 into the whitelist database of the UEFI.

12. The method of claim 1, wherein the network appliance prior to receipt of the trigger includes three partitions including:
a factory reset partition that includes a base image for the network appliance;
a current image partition that includes the active image; and
a rollback image partition that includes a previous image.

13. A non-transitory computer-readable medium having encoded therein programming code executable by one or more processors to perform or control performance of operations of upgrading images on a network appliance while preserving data on the network appliance, the operations comprising:
receiving a trigger to an upgrade the network appliance from an active image installed on the network appliance to an updated image, wherein the updated image includes an updated kernel and an updated ramdisk;
downloading, to the network appliance, an updated package including the updated image;
storing the updated package at the network appliance;
determining which partition of multiple partitions of the network appliance is an active image partition that is currently allocated to the active image;
further determining which partition of the multiple partitions of the network appliance is a factory reset partition, wherein the factory reset partition stores a factory reset image;
copying the updated kernel and the updated ramdisk to the factory reset partition;
modifying a main configuration file of a boot loader to access the updated kernel and the updated ramdisk in the factory reset partition;
reboot the network appliance such that the boot loader implements the modified main configuration file to access the updated kernel and the updated ramdisk from the factory reset partition and designating the factory reset image partition as an updated active image partition; and
mounting, by the updated kernel, the updated ramdisk and installation scripts using the updated package.

14. The non-transitory computer-readable medium of claim 13, wherein:
the boot loader is stored in a boot partition of the multiple partitions,
the boot partition is stored on SDA1;
the active image partition is stored on SDA2;
the factory reset partition and the updated active image partition are stored on SDA3; and
the updated package is stored on SDA11.

15. The non-transitory computer-readable medium of claim 13, wherein the operations further comprise:
receiving a subsequent trigger to upgrade the network appliance from the updated active image to a subsequent updated image, wherein the subsequent updated image includes a subsequent kernel and a subsequent ramdisk;
downloading, to the network appliance, a subsequent package of the subsequent updated image;
storing the subsequent package of the subsequent updated image to SDA11;
determining that a current active partition of the network appliance on which the upgraded active image is stored is SDA3;
copying the subsequent kernel and the subsequent ramdisk to SDA2;
modifying the main configuration file of the boot loader to point to SDA2;
reboot the network appliance such that the boot loader accesses the subsequent kernel and the subsequent ramdisk from SDA2 and the subsequent kernel mounts the subsequent ramdisk and installation scripts using the subsequent package.

16. The non-transitory computer-readable medium of claim 13, wherein:
the operations further comprise:
determining a current size of a boot partition on which the boot loader is stored;
responsive to the current size being below a particular size threshold, generating a backup of the boot partition contents and storing the backup under a data partition;
repartitioning the boot partition on a disk of the network appliance such that a new boot partition is generated with a second size, wherein the second size is greater than the current size;
running a grub install to force grub to read the new boot partition;
copying the backup back to the new boot partition; and
rebooting the network appliance such that the new boot partition having the second size is implemented on the network appliance and includes the backup; and
the determining the current size occurs after the trigger is received and prior to downloading the updated package of the updated image.

17. The non-transitory computer-readable medium of claim 13, wherein the operations further comprise removing a previous active image from a rollback image partition.

18. The non-transitory computer-readable medium of claim 13, wherein the operations further comprise:
replacing a basic input/output system (BIOS) with a unified extensible firmware interface (UEFI); and
replacing a grand unified bootloader (GRUB) legacy with GRUB2 in a boot partition.
generating a first asymmetric key pair configured for use in GRUB2 signing;
generating a second asymmetric key pair that is configured for use in kernel signing;
signing a GRUB2 binary file of the GRUB2;
signing a kernel binary file of the updated kernel; and
enrolling a public key of the first asymmetric key pair and the signature of the GRUB2 into a whitelist database of the UEFI,
wherein the updated package includes:
the signature of the GRUB2 binary file,
the public key of the first asymmetric key pair,
the signature of the kernel binary file,
a public key of the second asymmetric key pair, and
the UEFI includes a whitelist database that includes signatures of authorized bootloaders.

19. The non-transitory computer-readable medium of claim 18, wherein the replacing the GRUB legacy includes:
changing a partition type from a master boot record (MBR) to a GUID partition table;
creating an extensible firmware interface (EFI) system partition that acts as the boot partition
installing a GRUB binary of the GRUB2 into the EFI system partition; and
enrolling keys and a signature of the GRUB2 into the whitelist database of the UEFI.

20. The non-transitory computer-readable medium of claim 14, wherein the network appliance prior to receipt of the trigger includes three partitions including:
a factory reset partition that includes a base image for the network appliance;
a current image partition that includes the active image; and
a rollback image partition that includes a previous image.
